(19) United States
(12) Patent Application Publication
(10) Pub. No.: US 2001/0028662 A1
(43) Pub. Date: Oct. 11, 2001

(54) Method and system of real-time optimization and implementation of content and advertising programming decisions for broadcasts and narrowcasts

(76) Inventors: Paul M. Hunt, Okemos, MI (US); Steven K. Meuche, Holt, MI (US); Lou Anna K. Simon, East Lansing, MI (US)

Correspondence Address: Monte L. Falcoff, Harness, Dickey & Pierce, P.L.C., P. O. Box 828, Bloomfield Hills, MI, 48303, US

(21) Appl. No.: 09/736,456

(22) Filed: Dec. 14, 2000

Related U.S. Application Data
(60) Provisional application No. 60/176,641, filed on Jan. 18, 2000.

(51) Int. Cl. H04L 12/56

(52) U.S. Cl. 370/487; 370/389

(57) ABSTRACT

A system for adapting the content of a steam of user requested data elements having a computer processor for processing content selection, a storage media for storage of data elements, a data streaming delivery module functionally coupled to said computer processor which delivers the stream of data to the user, a real time tracking module which provides a first signal indicative of the number of users, a content selection module which determines which data elements are placed into the data stream based upon the value of the first signal.

### BACKGROUND OF THE INVENTION

The method, system and apparatus of the present invention relate generally to real-time optimization of broadcasts' and narrowcasts' program element and advertising element content, based on a real-time stratification of viewers or listeners currently receiving the broadcast or narrowcast programming elements or advertising elements via the internet. (Collectively, such programming elements and advertising elements are referred to herein simply as the “content”).

Prior to this invention, real-time optimization of programming and advertising on a seven day-a-week, twenty-four hour-a-day basis has not been practical, based on human decision-making and existing audience tracking methodologies. For example, Arbitron, Nielsen and similar rating services are currently available to radio and television broadcasters, but they typically do not deliver information as to the “success” of, or audience reaction to, a particular advertisement or programming element sooner than overnight. Usually, the ratings come weeks or even months after the content in question has been broadcast or narrowcast. Programming consulting services are commercially available as well. These consulting services provide advice on programming content in some specific broadcast formats (e.g. “top forty” music). In key markets their advice is often predicated on sales of pop “singles,” which is a very indirect surrogate for the actual music listening behavior patterns of audiences. Up until now, such consulting services have proven to be controversial, as their immediate benefit to advertisers or others outside of the music industry has been far from clear.

It is currently possible to track the number of internet listeners or viewers via automated monitoring of the traffic traversing a particular router, switch, or other similar network device. In this invention, real-time network traffic data is collected, characterizing the aggregate audience of internet viewers or listeners and measuring the number of those audience members being gained or lost per unit time, immediately before, during, or immediately following particular content is broadcast or narrowcast. This tracking serves two purposes: the development of a historical record of the empirically determined gain or loss of audience participants associated with each content element, and the real-time optimization of content being broadcast or narrowcast. Essentially instantaneous optimization of content choices is accomplished through an automated decision process that uses real-time audience levels, gains, and losses in conjunction with the historical track record of possible choices for follow-on content. The likelihood of achieving user-specified business goals is maximized through the empirically optimized choice of immediately subsequent content elements to be offered to the audience. Such business goals may include, but are not limited to:

(a) maximization of total audience;

(b) maximization of audience for content elements to be preferentially promoted by ensuring their transmission as “favored lead” elements when measured audiences are high due to popular predecessor elements;

(c) maximization of advertising profits by avoiding penalties or “make good” situations, due to the delivery of advertising with contractually guaranteed audience levels when such levels do not in fact exist;

(d) maximization of advertising profits by ensuring high audience premiums are obtained when possible, via the automated delivery of premium-paying advertising when strong audiences exist; and

(e) maximization of profits through the offer of services whereby advertisers with more than one advertising message are assured that their more popular advertisements will be preferentially transmitted to audiences over time, based on accumulating empirical information on the audience level gains and losses associated with each such message.

The utility of this new method of business is extended by using its real-time audience measurement to optimize programming in other transmission formats where equivalent measurements are difficult or impossible. Many stations are now transmitting identical programming via the internet as well as traditional broadcast and cable technologies. Under this new invention, internet listeners or viewers serve as behavioral surrogates for all contemporaneous listeners or viewers across all transmission formats. Measurement of internet audience behavior in real-time permits the real-time optimization of content choices transmitted simultaneously across all transmission formats: not just on the internet. This will also permit the economical study of a potentially very much larger audience sample (relative to traditional rating protocols, surveys, focus groups, etc.) as the entire instantaneous internet audience will be inexpensively and continuously monitored.

Internet transmitting technology generally gives local content providers world-wide reach. In doing so, the internet broadens both the potential audience and the possible advertisers for a particular transmitted programming data stream. Existing internet traffic measurement technologies provide information on the IP domains and geographical locales of transmission listeners and viewers. Thus, this new system and method of business also permits:

(i) the stratification of rating audiences by locale;

(ii) the optimization of advertising and programming content choices in light of instantaneous audience at a favored “significant” locale; and

(iii) the support of multiple advertising data streams with individually optimized programming and advertising content choices.

### SUMMARY OF THE INVENTION

In view of the aforementioned problems in the current transmission system, it is an object of the current invention to provide real-time stratification of viewers or listeners currently receiving broadcasts or narrowcast content or advertising via the internet.

It is further an object of the current invention to provide real-time data on the internet viewers or listeners gained or lost, derived from network packet or kilo bit per second traffic data within time slices of an arbitrary useful size (e.g., a fraction of the length of a pop music “single”).

It is further an object of the current invention to provide instantaneous delivery from digital storage to the internet and other transmission modes of multiple programming content and advertising choices of songs of a different type (for example oldies, rock fusion, country/western, etc.), classical performances by different artists or different periods or different composers, or using different instrumental settings and advertising spots of different length by different sponsors or different styles.

It is further an object of the current invention to utilize, as needed or as desirable, one or more of a multiplicity of automated, potentially continuously “learning” decision systems (e.g., expert systems, genetic algorithms, and/or neural networks, as well as deterministic logic) with which to optimize programming and advertising choices in real-time, using stored content in light of the stratified viewer or listener behavioral data being obtained.

The use of the invention should permit broadcasters and narrowcasters to obtain higher ratings, relative to inflexible, predetermined programming or unpredictable, real-time human-made programming decisions made without the benefit of real-time audience data. Higher ratings should command high advertising revenues.

The ability to offer advertisers real-time optimization of their messages should in itself command a premium. Advertisers who detect that a particular form of their message results in a significant number of “turned off” viewers or listeners in a particular programming context will be able to have such a message replaced automatically, potentially as early as the next reserved slot. This should be particularly advantageous in context where events beyond the advertiser's control or human programmers preplanning act to influence viewer or listener receptivity. For example, the effectiveness of alternative advertisements from a single fast food chain may vary in a baseball broadcast, based on whether a home team is winning, losing or sitting out a rain delay. This baseball game example also illustrates the potential utility of the invention for advertising optimization, even when no programming content optimization is possible.

Another significant advantage of this invention would be to those in the political arena who would be able to tailor their messages based on consumer demographics. Furthermore, the politicians and their consultants would be able to determine the effectiveness of messages with particular listening demographic groups. The invention's decision tools will use the extensive real-time data obtained from internet broadcasts and narrowcast as a conditional surrogate for similar but unobtained real-time viewer or listener behavior data pertaining to traditional broadcast or narrowcast transmissions (via television, radio, cable, etc.) of the same content or advertising. In other words, to the extent empirically justifiable, the internet viewer or listeners will act as a continuous sample set, modeling the behaviors of all viewer or listeners receiving the content and advertisement through any means.

Accomplishment of this objective predictably will entail the use of proprietary correlation data, reflecting the similarities and differences of viewer or listener behavior on the internet vis-a-vis the behavior of those receiving content and advertising via other transmission modes. The invention will be able to utilize and generate correlation data obtained in either or both of the two proprietary modes: either as data available from and/or provided to a commercial consulting service, or as enterprise-specific data pertaining to the content provider's own broadcasts or narrowcasts.

The invention will reflect the behavior of internet viewers or listeners in a way that traditional ratings do not, as their measurements typically are made in defined metropolitan areas. By contrast, data collected from the internet will permit stratification of listeners and viewers by geographical locations through their IP addresses, and this stratification can both inform and be reflective of the outcome of the automated decision process. For example, advertising rates can reflect the differential values and local and distant viewers to local versus national or global enterprises. As a second example, audience members with “.com” domain addresses may have different value to advertisers than those in “.edu” or “.mil” domains. Differences in domain address types being defined herein as “domain type.” In another example, the programming-driven gains and losses of foreign listeners to internet public radio shows might usefully be discounted relative to audience gains and losses of local contributors or U.S. taxpayers. In a significant advantage of the invention, real-time stratification of internet listeners or viewer by IP addresses will permit locale-appropriate advertising to be provided to them through the use of parallel streams of digital signals. For example, traffic reports normally sent to a metropolitan area can be replaced in the distant audience internet data stream with an advertisement or other content.

### BRIEF DESCRIPTION OF THE DRAWINGS

FIG. 1 is a block diagram describing the components of the system for real time optimization and implementation of content, including both advertising and programming decisions for broadcasts and narrowcasts.

FIGS. 2-4 are logical flow charts depicting one possible implementation of the real-time content selection software.

### DETAILED DESCRIPTION OF THE INVENTION

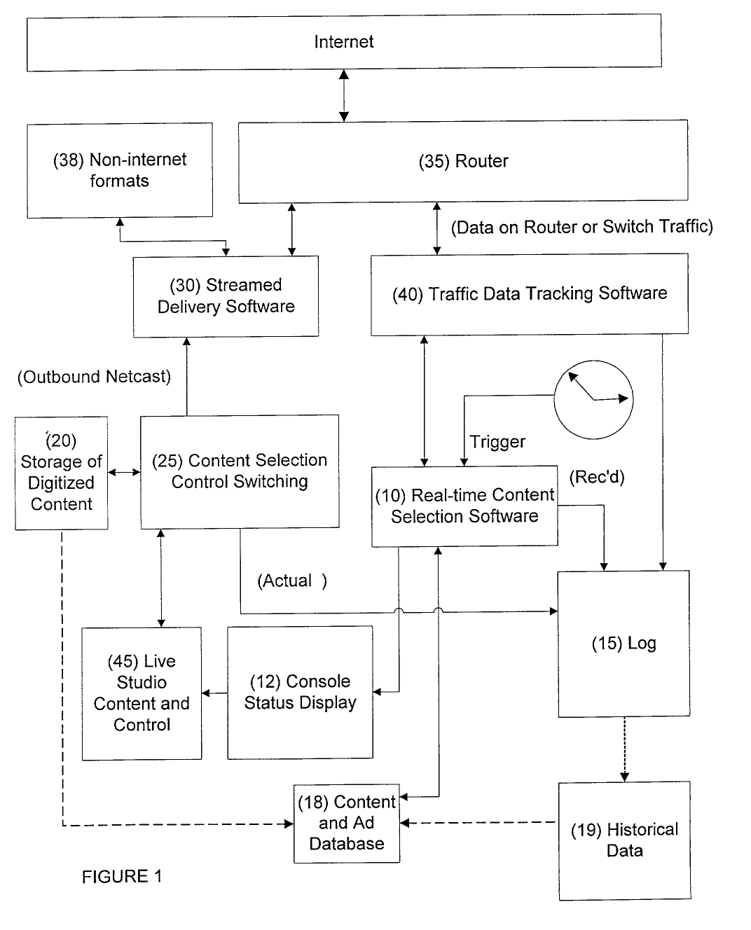

FIG. 1 shows a block diagram of the system, based around the real time content selection module 10, which includes one or more algorithms to analyze audience behavior and correspondingly optimize the content of a particular channel of data in real time. The algorithm(s) which are included in the real-time content selection module 10 may be based on deterministic logic, fuzzy logic, statistical regression analysis, neural networks or other optimization techniques. The real-time content selection module 10 would also contain or have electronic access to a pre-programmed default content schedule. Using whatever decision algorithm(s) it contains, the real-time content selection decision module “decides” to make changes in the pre-programmed default program content based on real-time measurements of viewer or listener behavior.

Statistics characterizing data requests from viewers/listeners to the router or switch 35 are collected by a real-time network traffic data tracking module 40. This information is stored in the log 15 for off-line research analysis and is also provided continuously to the real-time content selection module 10. It is preferred that the Multi Router Traffic Grapher, available under the GNU General Public License from the Department of Electrical Engineering of the Swiss Federal Institute of Technology-Zurich, be used for real-time traffic data tracking module, 40. MRTG combines a PERL script, a C program, and the Simple Network Management Protocol (SNMP) to obtain, manipulate, and report data characterizing traffic traversing a router 35 on the internet. For the commercially available router 35, many choices exist, such as those from Cisco Systems. Commercially available routers, switches, and related network devices broadly support SNMP and thus are readily interrogated by MRTG or other similar real-time traffic data tracking software.

Using the traffic real time network traffic provided to it by module 40, the real-time content selection module 10 determines its content decisions and stores them within the log 15 for offline research analysis and parameter optimization. After storage in the log 15, the network traffic data from tracking module 40 and the content selection decisions from real-time content selection module 10 offline data can be combined off-line with other data to form a database of stratified historical information 19. The historical database reflects the relative “effectiveness” of a particular advertising or programming content segment by correlating its identity with network traffic totals, network traffic gained or lost, the geographic location of viewers or listeners during it, time and date of transmission, and the effectiveness of predecessor and successor content elements.

Information on available content can be found in the available programming content and ad database 18. The available content elements are annotated in the available content and ad database 18 based upon the various effectiveness metrics that have been accumulated concerning those elements in the stratified historical database 19. The digitally stored programming and ad elements listed in the available content database 18 are themselves stored in commercially available mass storage 20; such mass storage is sometimes referred to as a “digital jukebox,” “video server,” etc. The preferred hardware for the commercial mass storage 20, is the Sony CDL-1100-20 holds up to 100 CD disks, totaling 65 Gigabytes of “near on-line” digital storage with two CD drives and a robotic “picker.” One such jukebox is capable of holding thousands of content elements. Nothing prevents the existence of more than one such mass storage device within the invention system and method of business, and new mass storage technologies further expand the possibilities for large-scale storage. For example, the Sony OSL-6000 is a possible alternative choice, holding up to 78 Gigabytes of data using ISO standard cartridges instead of 650 Megabyte CDs. Either choice is compatible with the Microsoft Windows NT operating system, and both support SCSI cable connections, thus permitting a standard PC running the NT operating system to perform the functions of a Content Selection Control module, 25. Of particular interest concerning such jukebox mass storage is the disk exchange time for any robotic picker involved therein, as it will substantially determine the lead time needed by the real-time content selection module 10 to queue up the next programming or advertising content element to be transmitted. The timing of trigger events, prior to the end of any content element, will need to ensure that the disk exchange time (and hence the much shorter automated decision process) occurs during the concluding element, so that “dead” time does not occur in the transmission. For illustration, published specifications for a Sony CDL-1100-20 suggest a “robotics only” average disk exchange time of 12.2 seconds.

When the real time content selection module 10 chooses a particular segment to be presented, it contacts the content selection control module 25. The content selection control switching module 25 accesses the mass storage 20 containing the digitized programming and advertising elements and forwards the desired data to the streamed delivery software 30. As will be further described below, this software 30 provides streams of data to viewers/listeners using different methods. Optionally included in this system is studio content and control override 45, which permits humans to view the automated decisions recommended by the real time content selection module 10 via the console status display 12 and then override them if necessary or desirable. (The system could also operated in an unattended mode.)

Real time tracking module 40 that measures internet traffic is in wide use. This module feeds data to the real-time content selection module 10 and the log 15 for off-line research. As a relevant example, Michigan State University monitors the traffic entailed in delivery of WKAR-FM and related content to its netcasting listenership. Internet netcasting is accomplished using standard streamed delivery software, such as that available from Real Networks. It is preferred that RealServer 7.0 from RealNetworks, Inc., is one possible current choice for streamed delivery software, 30.

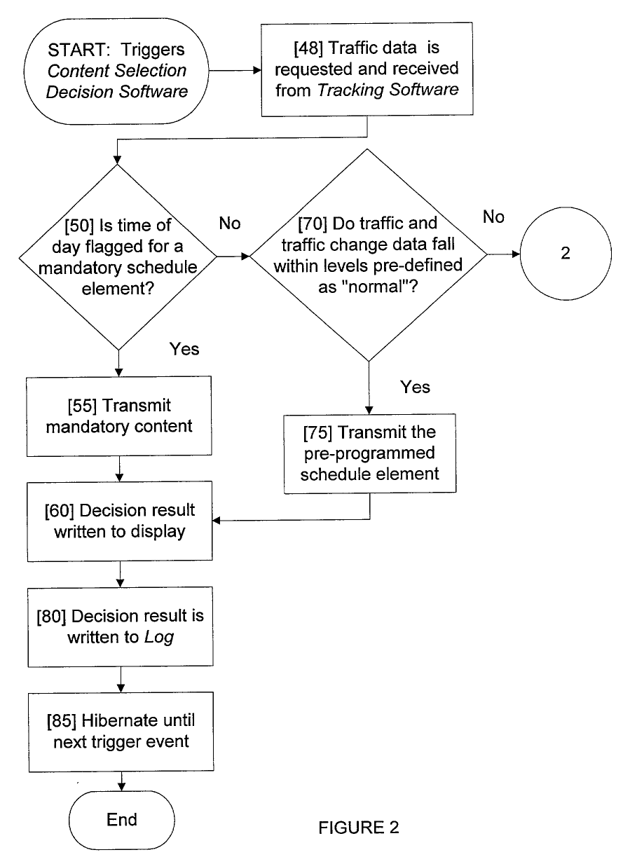

As described below, FIGS. 2-4 detail one possible decision algorithm that could be implemented as the real-time content selection module within the system and method of business described herein. As disclosed in process block 48 of FIG. 2, once an elapsed time or other event triggers the real-time content decision software, the most recent netcasting traffic data is requested and received from the real-time data tracking module. Process block 50 determines if it is the time of day for a flagged mandatory scheduling element in the pre-programmed default schedule. If decision block 50 determines that time of day is flagged for a mandatory scheduling element, process block 55 instructs the control content selection switch to transmit the mandatory content. Process block 60 then writes the decision result to the console's status display. If decision block 50 determines the time of day is not flagged for a mandatory scheduling element, then decision block 70 looks to see if the aggregate traffic and traffic change data fall within predetermined “nominal level.” If decision block 70 determines the aggregate traffic and traffic change data fall within these “nominal levels,” then in process block 75, the content control selection switch is instructed to transmit a pre-programmed schedule event. This decision result is written to the display status console in process block 60. Whether process block 60 has been reached via block 55 or block 70, the result is written to the log in process block 80. The real-time content selection module hibernates until the next timed triggering event, as shown in process block 85.

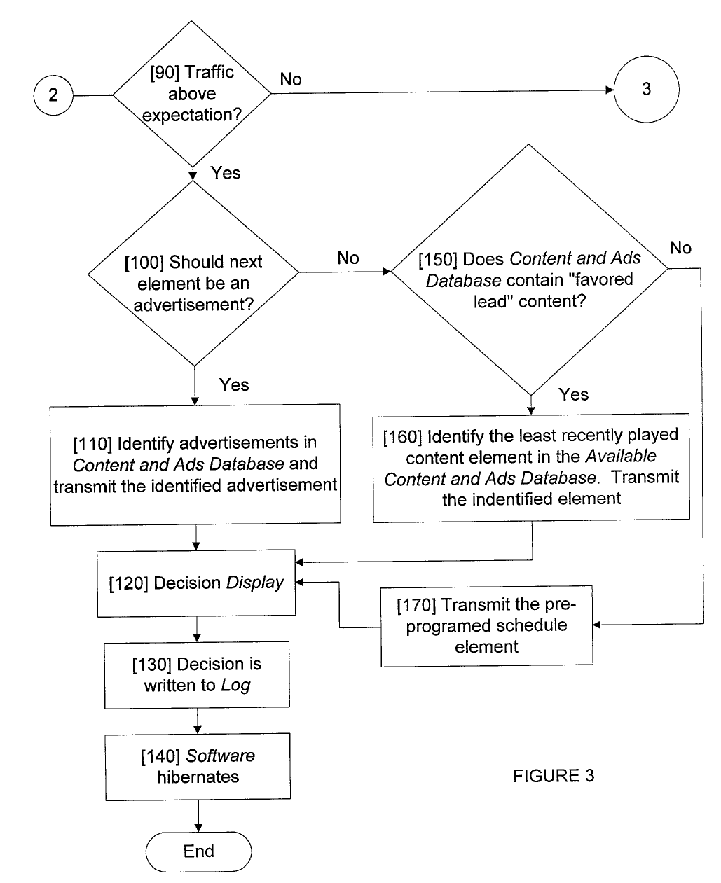

As best described in FIG. 3, should decision block 70 in FIG. 2 determine the aggregate traffic level and/or the traffic change data fall outside of a pre-determined “nominal level,” decision block 90 of the system then looks to see whether the instantaneous aggregate traffic is above expectation. If decision block 90 determines the instantaneous aggregate traffic is above expectation, then decision block 100 looks to see whether the next element should be an advertisement per the pre-programmed default schedule. If the next element should be an advertisement per the schedule, process block 110 identifies the least recently played of the time eligible, highest premium payment rate advertisements in the available content and ads database and then instructs the content control selection switch to transmit the identified advertisement. This decision result is written in process block 120 to the console status display and is subsequently written to the log in process block 130. The real-time content selection decision module then hibernates until the next triggering event, as shown in process block 140.

Should decision block 100 determine the next element is not an advertisement per the pre-programmed default schedule, the decision block 150 determines whether the available content and ads database contains time-eligible, “favored lead” content elements. Should process block 150 determine the available content and ads database does contain time-eligible, “favored lead” content elements, process block 160 identifies the least recently played, time-eligible, “favored lead” content element in the available content and ads database. The process block 160 instructs the control selection switch to transmit the identified element. This decision result is written in process block 120 to the display status console and it is subsequently written to the log in process block 130. The real-time content selection decision module then hibernates until the next trigger event, as shown in process block 140.

Should decision block 150 determine that the available content and ads database does not contain the time eligible “favored lead” content elements, process block 170 instructs the content control selection switch to transmit the preprogrammed schedule element. This decision result is written in process block 120 to the display status console and it is subsequently written in process block 130 to the log. The real-time content selection decision module then hibernates until the next triggering event, as shown in process block 140.

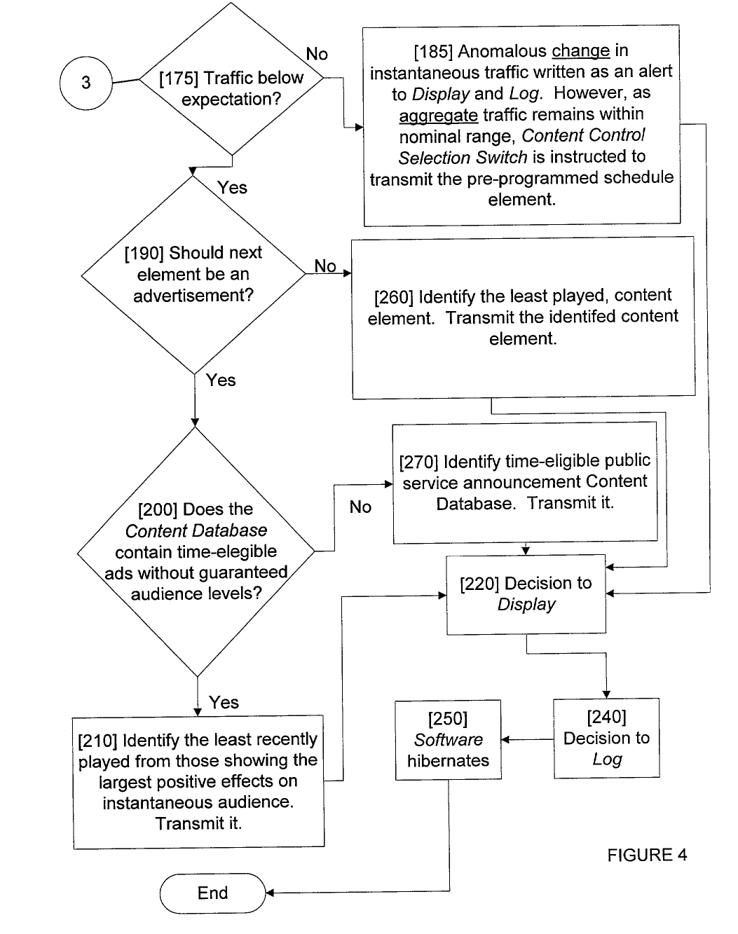

As best shown in FIG. 4, should decision block 90 in FIG. 3 determine the instantaneous aggregate traffic is not above expectation, then decision block 175 determines if the instantaneous aggregate traffic is below expectation. If so, then process block 190 determines if the next element should be an advertising element per the pre-programmed default schedule. If process block 190 determines the next element is an advertising element per schedule, decision block 200 determines if the available content and ads database contain time eligible ads without guaranteed audience levels in excess of the instantaneous aggregate audience. If decision block 200 determines the available content and ads database does contain time eligible ads without guaranteed audience levels in excess of the instantaneous aggregate audience, process block 210 identifies which of the ads has least recently been played from among those historically showing the largest positive effects on instantaneous audience and instructs the content control selection switch to transmit it. The decision is written in process block 220 to the status display console and it is subsequently written in process block 240 to the log. As shown in process block 250, the real-time content selection module then hibernates until the next triggering event.

Should decision block 175 find that the instantaneous aggregate traffic is not below expectations, process block 185 notes the existence of an anomalous change in instantaneous traffic and writes an alert to the console status display log. However, as aggregate traffic remains within the nominal range, content selection control is instructed in process block 185 to transmit the pre-programmed schedule events. This decision result is written in process block 220 to the console status display and it is subsequently written in process block 240 to the log. As shown in process block 250, the real-time content selection module hibernates until the next triggering event.

If decision block 175 determines the instantaneous aggregate traffic is below expectation and decision block 190 determines the next element in the queue is not an advertisement per the pre-programmed default schedule, decision block 200 will identify the least recently played, time-eligible content element from among those showing positive effects on instantaneous aggregate audience, and will instruct the control selection module switch to transmit the identified content element. This decision result is written in process block 220 to the console status display and it is subsequently written in process block 240 to the log. As shown in process block 250, the real-time content selection module hibernates until the next triggering event.

If decision block 175 determines that the instantaneous aggregate traffic is below expectation, decision block 190 determines that the next element is an advertisement per the schedule, and decision block 200 determines that the available content and ads database does not contain time-eligible ads without guaranteed audience levels in excess of the instantaneous aggregate audience, then process block 270 identifies the least recently played, time-eligible public service announcement in the available content and ads database and instructs the content selection switch to transmit it. This decision result is written in process block 220 to the console status display and it is subsequently written in process block 240 to the log. As shown in process block 250, the real-time content selection module hibernates until the next triggering event.

Music duration data from the available content and ads database would be used to calculate the timing of trigger events for the decision tool. Other trigger events (e.g., completion of “break-in” weather advisories, the conclusion of variable length sporting events, etc.) would also initiate the content selection process.

Use of the system to feed real-time optimized content and ads to traditional broadcasts and cablecasts, in addition to the internet netcasting, is accomplished by feeding the digital data to the radio control board or television broadcast switcher, in parallel with the same signal being sent to the internet streaming application.

Many possible decision algorithm system choices exist, including those employing one or more of deterministic logic, fuzzy logic, genetic algorithms, neural networks, regression analysis, expert systems, etc. Collectively, the various choices could supplement or replace the example of deterministic logic embodied in FIGS. 24, within the invention's same system and method of business. Furthermore, the term module should be interpreted broadly to include implementations using many various computer programming languages, tools, and techniques.

Variations in content selection decision software module implementation are likely to reflect and promote competition among content providers using the invention. When more than one competing content provider is using the invention in the same market, the option for use of a different decision algorithm could be exploited by each to provide distinct responsiveness to audiences in pursuit of a competitive advantage.

A wide variety of hardware and software choices exist for the “digital juke boxes” or other mass storage of content, for the streamed netcasting delivery software, for the network traffic statistical tracking, for the content control switch, for the status display consoles, and for the event logging and database software. To enable comprehension of a fully integrated system implementing the invention, some example choices are discussed below. As time passes and technology advances, successor products should constitute obvious replacement choices.

Regardless of the hardware component choices integrated within an implementation, the radically new system and method of business of the invention, consists fundamentally of the real-time monitoring of audiences for the automated, real-time optimization of programming content and advertising, including audience maximization, the avoidance of advertising “make goods” the capture of advertising premiums when possible, the stratification of audiences by listener type and locale, and the other objectives described above. From the above description of the invention, those skilled in the art will perceive improvements, changes and modifications. Such improvements, changes and modifications within the skill of the art are intended to be covered by the appended claims.

What is claimed is:

1. A system for adapting in real-time the content of a steam of user requested data elements comprising:
a computer processor for processing content selection;
storage media for storage of data elements functionally coupled to said computer processor;
a streaming data delivery module functionally coupled to said computer processor which delivers the stream of data to the user;
a real time tracking module which provides a first signal indicative of the number of users requests;
a content selection module which determines which data elements are placed into the stream of data based upon a schedule of data elements and the value of the first signal.

2. The system for adapting in real-time the content of the stream of user requested data elements of claim 1 wherein the real time data tracking module is configured to receive information about the number of requests for the data stream and calculate the incremental increase or decrease of users.

3. The system of claim 1 wherein the content selection module is configured to retrieve data elements from the storage media, the stream of data elements having an associated nominal level, the content selection module being operable to change the content of the stream of data if the first signal indicates the number of requests for the stream of data deviates by a predefined amount from the nominal level.

4. The system of claim 3 wherein the content selection module further determines which data elements are placed into the stream of data elements based on the time of day and is capable of determining whether the data elements should be an advertising element.

5. The system of claim 3 wherein the content selection module further determines which data elements are placed into the data stream based on the time of day and is capable of determining whether the data elements should be a time-eligible forward lead content element.

6. The system of claim 3 wherein the control selection module is capable of determining whether the storage media contains time-eligible premium payment rate advertisements having associated minimum viewer levels, and of determining if the first signal is indicative of a viewership higher than the minimum level;
the control selection module operable to insert the time-eligible premium payment rate advertisement into the data stream.

7. The system of claim 3 wherein the content selection module is capable of determining if the first signal is indicative of a drop in viewership and is capable of adding a time-eligible content element having a positive influence on viewership into the data stream.

8. The system of claim 3 wherein the content selection module is capable of determining if the first signal is indicative of an increase of viewership over the nominal level and is capable of adding time-eligible premium advertising data elements to the data stream.

10. A method of adapting the content of a data stream in real-time containing user requested data elements comprising:
tracking the number of requests for the data elements;
changing content of the data stream if the number of user requests falls below a predetermined level.

11. A method of adapting the content of a stream to a user containing data elements of data segments in real-time that are requested by a plurality of users comprising:
providing a data structure containing transmittable data segments;
providing a first modifiable program schedule which lists a nominal viewership level, and the order and time of transmission of the transmittable data segments to be transmitted;
determining a first property which is a function of the requests by the users of the data elements;
modifying the first modifiable program schedule if the first property is a predetermined amount from nominal viewership level.

12. The method of adapting in real-time the content of a stream of user requested data of claim 11 wherein the first property is a function of the number of requests by the users of the data elements within a given time period.

13. The method of adapting in real-time the content of a stream of user requested data segments of claim 11 wherein the first property is indicative of the locale of the requests by the users.

14. The method of adapting in real-time the content of a stream of user requested data of claim 11 wherein the first property is indicative of the internet domain type of the users.

15. The method of adapting in real-time the content of a stream of user requested data of claim 12 wherein the first modifiable program schedule lists in a first location a first advertisement data segment, having a first value which is capable of being compared to the first property; and further includes the step of removing first advertisement data segment from said first modifiable program schedule if the first property is below the first value.

16. The method of adapting in real-time the content of a stream of user requested data of claim 11 wherein the data structure containing transmittable data segments contains a first advertisement data segment listed in the first modifiable program schedule, having a first value which is capable of being compared to the first property further includes the step of removing first advertisement data segment from said data structure if the first property is a predetermined amount from the first value.

17. The method of adapting in real-time the content of a stream of user requested data of claim 15 further including the steps of listing a second data segment in the first location of the first modifiable program schedule.

18. The method of adapting in real-time the content of a stream of user requested data of claim 16 further including the step of listing a second data segment in the first location of the first modifiable program schedule.

19. The method of adapting in real-time the content of a stream of user requested data of claim 12 wherein the first modifiable program schedule lists a second data segment and wherein said first property is at least predetermined amount from nominal viewership level; and further including the step of inserting a first advertisement data segment into the modifiable program schedule after the second data segment.

20. The method of adapting in real-time the content of a stream of user requested data of claim 11 wherein the first modifiable program schedule lists a second data segment and further including the step of inserting said first advertisement data segment into the stream of data if the first property is above a predetermined amount from the nominal viewership level.

21. The method of adapting in real-time the content of a stream of user requested data of claim 11 further including the steps of providing a second modifiable program schedule which lists the order and time of transmission of a transmittable data segments to be transmitted in a second stream of data; determining a first property of the requests by users of the first stream of data; modifying the second modifiable program schedule if the first property is a predetermined amount from the nominal viewership level.

22. The method of adapting in real-time the content of a stream of user requested data of claim 12 further including the steps of providing a second modifiable program schedule which lists the content of a second modifiable stream the transmittable data segments;
modifying the second modifiable stream of data segments if the first property falls below a predetermined value.

23. The method of adapting in real-time the content of a stream of user requested data of claim 22 wherein the steps of modifying the second modifiable stream the transmittable data segments includes inserting a first advertisement data segment into the stream of transmittable data.

24. The method of adapting in real-time the content of a stream of user requested data of claim 11 further including the steps of providing a second modifiable program schedule which lists the content of a second modifiable stream the transmittable data segments;
modifying the second modifiable stream of data segments if the first property falls below a first determinable value.

25. The method of adapting in real-time the content of a stream of user requested data of claim 24 wherein the first property is a function of the number of requests by the users of the data elements within a given time period.

26. The method of adapting in real-time the content of a stream of user requested data of claim 24 wherein the first property is a function of the local of the requests by the users.

27. The method of adapting in real-time the content of a stream of user requested data of claim 24 wherein the first property is indicative of the domain type of the users.

28. An apparatus for adapting the content of a stream of user requested data elements comprising:
a computer processor for processing content selection;
a storage media for storing data elements functionally coupled to said computer processor;
a data stream delivery module functionally coupled to said computer processor which delivers the stream of data to the user;
a tracking module which provides a first signal indicative of the number of user requests within a predetermined time interval;
a timing element that defines a predetermine time interval based upon the size of a transmitted data element;
a content selection module which determines which data elements are transmitted in the stream of data based upon a schedule of data elements and the value of the first signal within said predetermined time interval.

29. The apparatus of claim 27 for adapting the content of the stream of user requested data wherein the data tracking module is configured to calculate intermittent increase or decrease in users within said predetermined time interval.

30. The apparatus of claim 27 wherein the content selection module is capable of retrieving data elements from the storage media, the stream of user registered data having an associated nominal level, the content selection module being operable to change the content of the stream of data if the first signal is indicative of a number of requests for the stream of data is a predetermined amount from the nominal level.

31. The apparatus of claim 27 wherein said data elements are comprised of a second set of data elements having an associated second value indicative of the time of day.

32. The apparatus of claim 27 wherein a third set of data elements having a third associated value indicative of a minimum required viewership level.

33. The apparatus of claim 27 wherein said data elements are comprised of a fourth set of data elements having an assigned value indicative of a favored lead element.

34. The apparatus of claim 27 wherein said data elements are comprised of a fifth set of data elements having an assigned value indicative of a public service announcement.

35. The apparatus of claim 27 wherein said data elements are comprised of a sixth set of data elements having a sixth variable indicative of a local flag.

36. A method of adapting the content of the stream of data containing user requested data elements comprising:
establishing a predetermined time interval based on the size of the data elements;
tracking the number of user requests for the data elements;
changing the content of the data stream fully within the predetermined time interval if the number of user requests falls below the predetermined level.

37. A method of adapting the content of a data stream to a user containing data elements of data segments requested by a plurality of users comprising:
providing a data structure containing transmittable data segments;
providing a first modifiable program schedule which lists a nominal viewership level and the order of transmission of transmittable data segments.
determining a first property which is a function of the number of requests by the users of the data elements within a given time period;
establishing a predetermined time interval based upon the size of the data segments;
modifying the first modifiable program schedule if the first property is a predetermined amount from the nominal viewership level for any given data segments.

38. The method of claim 37 wherein providing a data base includes providing data elements having first associated value indicative of the time of day.

39. The method of claim 37 wherein providing a data base includes providing data elements having a second associated value indicative of a minimum viewership level.

40. The method of claim 37 wherein providing a data base includes providing data elements having a third associated value indicative of the indicative of a public service announcement.
